(19) United States
(12) Patent Application Publication
(10) Pub. No.: US 2019/0042633 A1
(43) Pub. Date: Feb. 7, 2019

(54) SYSTEM AND METHOD FOR MANAGING DEVICES USING SNAPSHOT PARAMETER SEARCH

(71) Applicant: Yokogawa Electric Corporation, Tokyo (JP)

(72) Inventors: Cheng XU, Singapore (SG); Mamerto Perez GIANGO, Singapore (SG)

(73) Assignee: Yokogawa Electric Corporation, Tokyo (JP)

(21) Appl. No.: 15/669,390

(22) Filed: Aug. 4, 2017

(51) Int. Cl. G06F 17/30

(52) U.S. Cl. CPC G06F 17/30554; G06F 17/30398; G06F 17/3056

(57) ABSTRACT

A system for snapshot search over a plurality of devices in an industrial plant includes a snapshot search prompt interface and a snapshot search result interface. The snapshot search prompt interface is configured to receive entry of search criterion, edit the search criterion entered, display one or more search criterion candidates based on the search criterion entered or edited, and output together selected search criterion and a request for snapshot search for snapshots of parameters under the search criterion for one or more of the plurality of devices. The snapshot search result interface is configured to acquire a snapshot search result which includes one or more searched snapshots of parameters that match the search criterion, and display the snapshot search result which includes the one or more searched snapshots of parameters that match the search criterion, associated with the selected search criterion.

### TECHNICAL FIELD

Embodiments of the present invention generally relate to a system and a method for snapshot search over a plurality of devices in an industrial plant.

### BACKGROUND ART

Managing control devices through historical parameter snapshots in a mobile computing device has been done manually by going through the whole offline database in order to find the desired parameter snapshots to gather device information.

In a mobile computing device, parameter snapshots of various devices are downloaded to its database as time goes by. These snapshots contain information that are needed for a technical person to manage those devices. Currently, since the database is organized on snapshot level, meaning there will be no indexing for internal data, user or operator will need to browse all these snapshots and open them manually to find the needed information, hence manage the device. For huge database, it will be time consuming for the user to browse through all the parameter snapshots. Some parameter snapshot contains thousands of parameter information internally. In that case, it will be hard to locate the desired information of a particular parameter. User will not be able to observe the coherence among different snapshots when manually browsing the snapshots one by one.

### SUMMARY

In some aspects, a system for snapshot search over a plurality of devices in an industrial plant may include, but is not limited to, a snapshot search prompt interface and a snapshot search result interface. The snapshot search prompt interface is configured to receive entry of search criterion. The snapshot search prompt interface is configured to edit the search criterion entered. The snapshot search prompt interface is configured to display one or more search criterion candidates based on the search criterion entered or edited. The snapshot search prompt interface is configured to output together selected search criterion and a request for snapshot search for snapshots of parameters under the search criterion for one or more of the plurality of devices. The snapshot search result interface is configured to acquire a snapshot search result which includes one or more searched snapshots of parameters that match the search criterion. Each of the snapshots includes one or more parameters that represent a state of a respective one of the plurality of devices at a respective point of time. The snapshot search result interface is configured to display the snapshot search result which includes the one or more searched snapshots of parameters that match the search criterion, associated with the selected search criterion. The snapshot search prompt interface and the snapshot search result interface are implemented by one or more display screens of one or more display devices, one or more hardware processors and one or more software components including instructions to be executed by the one or more hardware processors.

### BRIEF DESCRIPTION OF THE DRAWINGS

FIG. 1 is a block diagram illustrating a snapshot search system for managing a plurality of field devices in some embodiments.

FIG. 2 is view of a display screen showing search candidates and search criterion before a snapshot searching is conducted by the snapshot search system shown in FIG. 1.

FIG. 3 is view of a display screen showing all matched searching result after a snapshot searching is conducted by the snapshot search system shown in FIG. 1.

FIG. 4 is a flow chart of the snapshot search process to be performed by the snapshot search system shown in FIG. 1.

FIG. 5 is a table of parameter types, available candidates and meanings of candidates.

### EMBODIMENTS

In some aspects, a system for snapshot search over a plurality of devices in an industrial plant may include, but is not limited to, a snapshot search prompt interface and a snapshot search result interface. The snapshot search prompt interface is configured to receive entry of search criterion. The snapshot search prompt interface is configured to edit the search criterion entered. The snapshot search prompt interface is configured to display one or more search criterion candidates based on the search criterion entered or edited. The snapshot search prompt interface is configured to output together selected search criterion and a request for snapshot search for snapshots of parameters under the search criterion for one or more of the plurality of devices. The snapshot search result interface is configured to acquire a snapshot search result which includes one or more searched snapshots of parameters that match the search criterion. Each of the snapshots includes one or more parameters that represent a state of a respective one of the plurality of devices at a respective point of time. The snapshot search result interface is configured to display the snapshot search result which includes the one or more searched snapshots of parameters that match the search criterion, associated with the selected search criterion. The snapshot search prompt interface and the snapshot search result interface are implemented by one or more display screens of one or more display devices, one or more hardware processors and one or more software components including instructions to be executed by the one or more hardware processors.

In other aspects, a snapshot search system for snapshot search over a plurality of devices such as field devices in an industrial plant may include, but is not limited to, one or more display devices having one or more display screens, one or more hardware processors, and one or more software components including instructions to be executed by the one or more hardware processors. The one or more software components include instructions to receive entry of search criterion. The one or more software components include instructions to edit the search criterion entered. The one or more software components include instructions to display, on the one or more display screens, one or more search criterion candidates based on the search criterion entered or edited. The one or more software components include instructions to output together selected search criterion and a request for snapshot search for snapshots of parameters under the search criterion for one or more of the plurality of devices. The one or more software components include instructions to acquire a snapshot search result which includes one or more searched snapshots of parameters that match the search criterion. Each of the snapshots includes one or more parameters that represent a state of a respective one of the plurality of devices at a respective point of time. The one or more software components include instructions to display the snapshot search result which includes the one or more searched snapshots of parameters that match the search criterion, associated with the selected search criterion.

In still other aspects, an apparatus for snapshot search over a plurality of devices such as field devices in an industrial plant may include, but is not limited to, one or more display devices having one or more display screens, one or more hardware processors, and a snapshot search system. The snapshot search system includes logic to receive entry of search criterion. The snapshot search system includes logic to edit the search criterion entered. The snapshot search system includes logic to display, on the one or more display screens, one or more search criterion candidates based on the search criterion entered or edited. The snapshot search system includes logic to output together selected search criterion and a request for snapshot search for snapshots of parameters under the search criterion for one or more of the plurality of devices. The snapshot search system includes logic to acquire a snapshot search result which includes one or more searched snapshots of parameters that match the search criterion. Each of the snapshots includes one or more parameters that represent a state of a respective one of the plurality of devices at a respective point of time. The snapshot search system includes logic to display the snapshot search result which includes the one or more searched snapshots of parameters that match the search criterion, associated with the selected search criterion.

The above described snapshot search system or apparatus described above can be implemented by in part or entirely artificial intelligence. The artificial intelligence snapshot search system can include snapshot search technology, fuzzy logic and neural networks that enable user to automatically conduct snapshot search over a plurality of field devices in a plant.

In some cases, the snapshot search result interface is configured to identify one or more snapshots or parameters selected from the searched snapshots of parameters that match the selected search criterion.

In other cases, the snapshot search system may include, but is not limited to, the one or more software components include instructions to identify one or more snapshots or parameters selected from the searched snapshots of parameters that match the selected search criterion.

In still other cases, the snapshot search system may include, but is not limited to, logic to identify one or more snapshots or parameters selected from the searched snapshots of parameters that match the selected search criterion.

In some cases, the snapshot search result includes at least one snapshot set that includes a set of parameters which represents a history of status at a plurality of different points of time of a respective device of the plurality of devices.

In some cases, the system may further include, but is not limited to, a snapshot storage. The snapshot storage can be implemented by, but is not limited to, such as a snapshot database or a snapshot repository. The snapshot storage stores a plurality of snapshot sets for the plurality of devices, wherein each snapshot set includes a set of parameters which represents a history of status at a plurality of different points of time of a respective device of the plurality of devices.

In some cases, the system may further include, but is not limited to, a device management application configured to receive, from the snapshot search prompt interface, the selected search criterion and the request for snapshot search for snapshots of parameters under the search criterion for one or more of the plurality of devices. The device management application is configured to have an access to the storage. The device management application is configured to perform a snapshot search over all snapshots of parameters stored in the snapshot storage on the basis of the selected search criterion and the request for snapshot search for snapshots of parameters under the search criterion for one or more of the plurality of devices to obtain the snapshot search result which includes the one or more searched snapshots of parameters that match the search criterion. The device management application is configured to send the snapshot search result to the snapshot search result interface. The snapshot search prompt interface, the snapshot search result interface and the device management application are implemented by the one or more display screens of the one or more display devices, the one or more hardware processors and the one or more software components including instructions to be executed by the one or more hardware processors.

In other cases, the snapshot search system may include, but is not limited to, the one or more software components include instructions to receive, from the snapshot search prompt interface, the selected search criterion and the request for snapshot search for snapshots of parameters under the search criterion for one or more of the plurality of devices. The snapshot search system may include, but is not limited to, the one or more software components include instructions to have an access to the storage. The snapshot search system may include, but is not limited to, the one or more software components include instructions to perform a snapshot search over all snapshots of parameters stored in the snapshot storage on the basis of the selected search criterion and the request for snapshot search for snapshots of parameters under the search criterion for one or more of the plurality of devices to obtain the snapshot search result which includes the one or more searched snapshots of parameters that match the search criterion.

In still other cases, the snapshot search system may include, but is not limited to, logic to receive, from the snapshot search prompt interface, the selected search criterion and the request for snapshot search for snapshots of parameters under the search criterion for one or more of the plurality of devices. In still other cases, the snapshot search system may include, but is not limited to, logic to have an access to the storage. In still other cases, the snapshot search system may include, but is not limited to, logic to perform a snapshot search over all snapshots of parameters stored in the snapshot storage on the basis of the selected search criterion and the request for snapshot search for snapshots of parameters under the search criterion for one or more of the plurality of devices to obtain the snapshot search result which includes the one or more searched snapshots of parameters that match the search criterion.

In some cases, the snapshot search result interface is configured to identify one or more selected snapshots or parameters which are selected from the snapshot search result which includes the one or more searched snapshots of parameters that match the search criterion. The device management application is configured to receive the one or more selected snapshots or parameters from the snapshot search result interface. The device management application is configured to manage one or more devices based on the one or more selected snapshots or parameters.

In other cases, the snapshot search system may include, but is not limited to, the one or more software components include instructions to identify one or more selected snapshots or parameters which are selected from the snapshot search result which includes the one or more searched snapshots of parameters that match the search criterion. The snapshot search system may include, but is not limited to, the one or more software components include instructions to receive the one or more selected snapshots or parameters and manage one or more devices based on the one or more selected snapshots or parameters.

In still other cases, the snapshot search system may include, but is not limited to, logic to identify one or more selected snapshots or parameters which are selected from the snapshot search result which includes the one or more searched snapshots of parameters that match the search criterion. In still other cases, the snapshot search system may include, but is not limited to, logic to receive the one or more selected snapshots or parameters and manage one or more devices based on the one or more selected snapshots or parameters.

In some cases, the device management application is configured to be communicatively coupled to the plurality of devices such as field devices in a plant. The device management application is configured to acquire a snapshot of parameter from one or more of the plurality of devices. The device management application is configured to store the snapshot of parameter in the snapshot storage.

In other cases, the snapshot search system may include, but is not limited to, the one or more software components include instructions to communicate to the plurality of devices such as field devices in a plant. In other cases, the snapshot search system may include, but is not limited to, the one or more software components include instructions to acquire a snapshot of parameter from one or more of the plurality of devices and store the snapshot of parameter in the snapshot storage.

In still other cases, the snapshot search system may include, but is not limited to, logic to communicate to the plurality of devices such as field devices in a plant. In still other cases, the snapshot search system may include, but is not limited to, logic to acquire a snapshot of parameter from one or more of the plurality of devices and store the snapshot of parameter in the snapshot storage.

In some cases, the device management application is configured to reflect the one or more selected snapshots or parameters to one or more other devices as one or more target devices that have the one or more selected snapshots or parameters.

In other cases, the snapshot search system may include, but is not limited to, the one or more software components include instructions to reflect the one or more selected snapshots or parameters to one or more other devices as one or more target devices that have the one or more selected snapshots or parameters.

In still other cases, the snapshot search system may include, but is not limited to, logic to reflect the one or more selected snapshots or parameters to one or more other devices as one or more target devices that have the one or more selected snapshots or parameters.

In some cases, the device management application is configured to identify one or more alarms from the snapshots as the search results.

In other cases, the snapshot search system may include, but is not limited to, the one or more software components include instructions to identify one or more alarms from the snapshots as the search results.

In still other cases, the snapshot search system may include, but is not limited to, logic to reflect the one or more selected snapshots or parameters to one or more other devices as one or more target devices that have the one or more selected snapshots or parameters.

In some cases, the device management application is configured to identify one or more causes for the one or more alarms identified.

In other cases, the snapshot search system may include, but is not limited to, the one or more software components include instructions to identify one or more causes for the one or more alarms identified.

In still other cases, the snapshot search system may include, but is not limited to, logic to identify one or more causes for the one or more alarms identified.

In some cases, the device management application is configured to identify devices to which the same alarm is applied, the devices being included in the plurality of devices.

In other cases, the snapshot search system may include, but is not limited to, the one or more software components include instructions to identify devices to which the same alarm is applied, the devices being included in the plurality of devices.

In still other cases, the snapshot search system may include, but is not limited to, logic to identify devices to which the same alarm is applied, the devices being included in the plurality of devices.

In some cases, the device management application is configured to compare parameters of the snapshots as the search result between at least two different devices included in the plurality of devices.

In other cases, the snapshot search system may include, but is not limited to, the one or more software components include instructions to compare parameters of the snapshots as the search result between at least two different devices included in the plurality of devices.

In still other cases, the snapshot search system may include, but is not limited to, logic to compare parameters of the snapshots as the search result between at least two different devices included in the plurality of devices.

In some cases, the device management application is configured to filter parameters of the snapshots as the search result.

In other cases, the snapshot search system may include, but is not limited to, the one or more software components include instructions to filter parameters of the snapshots as the search result.

In still other cases, the snapshot search system may include, but is not limited to, logic to filter parameters of the snapshots as the search result.

In some cases, the device management application is configured to sort parameters of the snapshots as the search result.

In other cases, the snapshot search system may include, but is not limited to, the one or more software components include instructions to sort parameters of the snapshots as the search result.

In still other cases, the snapshot search system may include, but is not limited to, logic to sort parameters of the snapshots as the search result.

In some cases, the device management application is configured to display at least one of trend and coherence among the snapshots as the search results in different points of time over at least two devices included in the plurality of devices.

In other cases, the snapshot search system may include, but is not limited to, the one or more software components include instructions to display at least one of trend and coherence among the snapshots as the search results in different points of time over at least two devices included in the plurality of devices.

In still other cases, the snapshot search system may include, but is not limited to, logic to display at least one of trend and coherence among the snapshots as the search results in different points of time over at least two devices included in the plurality of devices.

In some cases, the device management application system is integrated in a system configured to perform at least one of management and control to the plurality of devices.

In other cases, the snapshot search system including the one or more software components include instructions is integrated in a system configured to perform at least one of management and control to the plurality of devices.

In still other cases, the snapshot search system including logics is integrated in a system configured to perform at least one of management and control to the plurality of devices.

In some cases, types of parameters of the snapshots as the search result include string, numeric, bitenum, enum, date, and combination of date and time.

In other aspects, a plant management system may include, but is not limited to, a snapshot storage including at least one of a database and a repository that stores a plurality of snapshot sets for a plurality of devices in an industrial plant, wherein each snapshot set includes a set of parameters which represents a history of status at a plurality of different points of time of a respective device of the plurality of devices. The plant management system may include, but is not limited to, a snapshot search prompt interface, a device management application, and a snapshot search result interface. The snapshot search prompt interface, the snapshot search result interface and the device management application are implemented by a display screen of a display device, one or more hardware processors and the one or more software components including instructions to be executed by the one or more hardware processors.

The snapshot search prompt interface is configured to receive entry of search criterion. The snapshot search prompt interface is configured to edit the search criterion entered. The snapshot search prompt interface is configured to display one or more search criterion candidates based on the search criterion entered or edited. The snapshot search prompt interface is configured to output selected search criterion and a request for snapshot search for snapshots of parameters under the search criterion for one or more of the plurality of devices.

The device management application is configured to acquire each snapshot set from the respective device of the plurality of devices. The device management application is configured to store each snapshot set in the snapshot storage. The device management application is configured to receive, from the snapshot search prompt interface, the selected search criterion and the request for snapshot search for snapshots of parameters under the search criterion for one or more of the plurality of devices. The device management application is configured to have an access to the storage. The device management application is configured to perform a snapshot search over all snapshots of parameters stored in the snapshot storage on the basis of the selected search criterion and the request for snapshot search for snapshots of parameters under the search criterion for one or more of the plurality of devices to obtain the snapshot search result which includes the one or more searched snapshots of parameters that match the search criterion.

The snapshot search result interface is configured to receive, from the device management application, the snapshot search result which includes one or more searched snapshots of parameters that match the search criterion, each of the snapshots including one or more parameters that represent a state of a respective one of the plurality of devices at a respective point of time, the snapshot search result interface configured to display the snapshot search result which includes the one or more searched snapshots of parameters that match the search criterion, associated with the selected search criterion.

The snapshot search result interface is configured to identify one or more selected snapshots or parameters which are selected from the snapshot search result which includes the one or more searched snapshots of parameters that match the search criterion.

The device management application is configured to receive the one or more selected snapshots or parameters from the snapshot search result interface, the device management application is configured to manage one or more devices based on the one or more selected snapshots or parameters.

The device management application is configured to reflect the one or more selected snapshots or parameters to one or more other devices as one or more target devices that have the one or more selected snapshots or parameters.

In other aspects, a computer-implemented method for snapshot search over a plurality of devices in an industrial plant may include, but is not limited to, receiving entry of search criterion; editing the search criterion; displaying, on one or more display screens of one or more display devices, one or more search criterion candidates based on the search criterion entered or edited; outputting selected search criterion and a request for snapshot search for snapshots of parameters under the search criterion for one or more of the plurality of devices; performing a snapshot search over all snapshots of parameters stored in a snapshot storage on the basis of the selected search criterion and the request for snapshot search for snapshots of parameters under the search criterion for one or more of the plurality of devices; acquiring a snapshot search result which includes one or more searched snapshots of parameters that match the search criterion, wherein each of the snapshots including one or more parameters represent a state of a respective one of the plurality of devices at a respective point of time; and displaying, the on one or more display screens of the one or more display devices, the snapshot search result which includes the one or more searched snapshots of parameters that match the search criterion, associated with the selected search criterion.

The computer-implemented method may further include, but is not limited to, identifying one or more selected snapshots or parameters which are selected from the snapshot search result which includes the one or more searched snapshots of parameters that match the search criterion for managing one or more devices based on the one or more selected snapshots or parameters.

The computer-implemented method may further include, but is not limited to, reflecting the one or more selected snapshots or parameters to one or more other devices as one or more target devices that have the one or more selected snapshots or parameters.

The computer-implemented method may further include, but is not limited to, displaying, on one or more display screens of the one or more display devices, at least one of trend and coherence among the snapshots as the search results in different points of time over at least two devices included in the plurality of devices.

In sill other aspects, a non-transitory computer readable storage medium that stores computer-executable instructions or codes, when executed by one or more hardware processing devices, to cause the one or more hardware processing devices to perform as at least: a snapshot search prompt interface and a snapshot search result interface. The snapshot search prompt interface is configured to receive entry of search criterion, the snapshot search prompt interface configured to edit the search criterion entered, the snapshot search prompt interface configured to display one or more search criterion candidates based on the search criterion entered or edited, the snapshot search prompt interface configured to output selected search criterion and a request for snapshot search for snapshots of parameters under the search criterion for one or more of the plurality of devices. The snapshot search result interface is configured to acquire a snapshot search result which includes one or more searched snapshots of parameters that match the search criterion, each of the snapshots including one or more parameters that represent a state of a respective one of the plurality of devices at a respective point of time, the snapshot search result interface configured to display the snapshot search result which includes the one or more searched snapshots of parameters that match the search criterion, associated with the selected search criterion.

### ILLUSTRATIVE EMBODIMENTS

[Configuration]

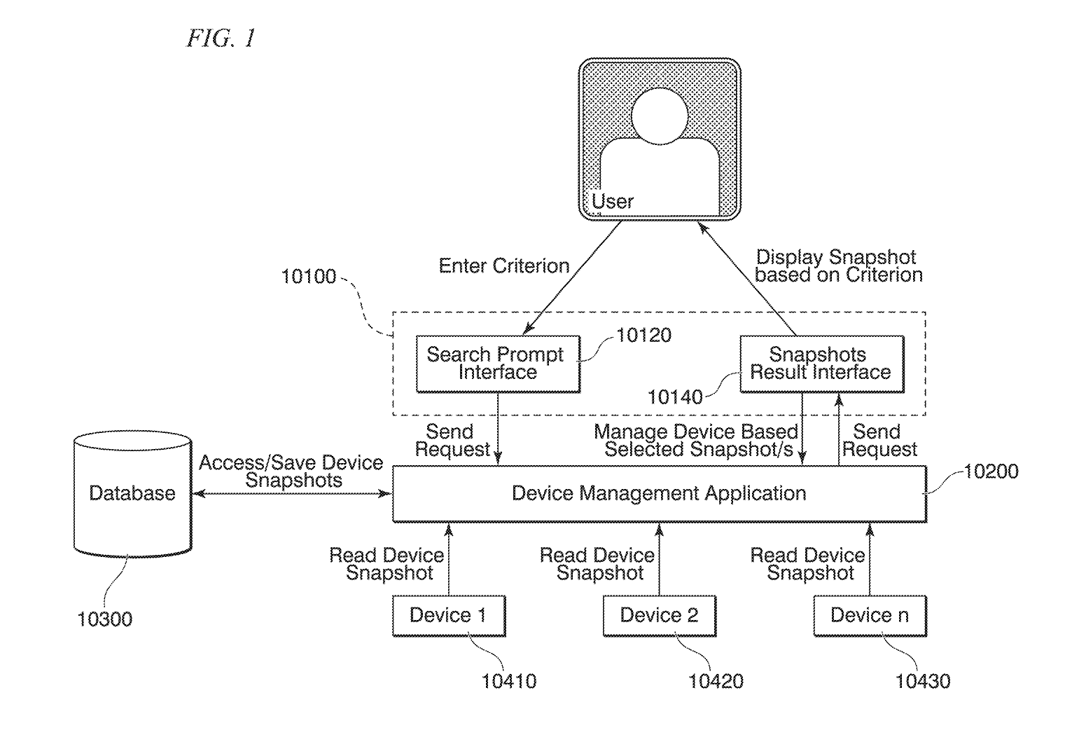

Some embodiments will be described with reference to the drawings. FIG. 1 is a block diagram illustrating a snapshot search system for managing a plurality of field devices 10410, 10420, and 10430 which are installed in an industrial plant. The plant management system includes a device management application 10200, a snapshot database 10300 and a snapshot search interface 10100. The snapshot search interface 10100 is configured to be used by a user or operator to conduct snapshot search through the device management application 10200 and the snapshot database 10300. The snapshot search interface 10100 has a snapshot search prompt interface 10120 and a snapshot search result interface 10140.

The snapshot search interface 10100 for snapshot search over a plurality of devices 10410, 10420, and 10430 in an industrial plant has the snapshot search prompt interface 10120 and the snapshot search result interface 10140. The snapshot search prompt interface 10120 is configured to receive entry of search criterion from user or operator. The snapshot search prompt interface 10120 is configured to edit, by user or operator, the search criterion once entered. The snapshot search prompt interface 10120 is configured to display, on a display screen 20000, search criterion candidates 1, 2, 3 and 4 based on the search criterion entered or edited as shown in FIG. 2, so that user or operator can review and select one of the search criterion candidates and a search request button “Search”. Upon selection by user or operator of one of the search criterion candidates 1, 2, 3 and 4 and pushing by user or operator the button of the search request button “Search”, the snapshot search prompt interface 10120 is configured to output together selected search criterion and a request for snapshot search for snapshots of parameters under the search criterion that is selected by user or operator for one or more of the plurality of devices 10410, 10420, and 10430. The snapshot search prompt interface 10120 is configured to send the together the selected search criterion and the request for snapshot search for snapshots of parameters under the search criterion that is selected by user or operator.

The device management application 10200 is configured to receive, from the snapshot search prompt interface 10120, the selected search criterion and the request for snapshot search for snapshots of parameters under the search criterion for one or more of the plurality of devices 10410, 10420, and 10430. The device management application 10200 is configured to have an access to the snapshot database 10300. The device management application 10200 is configured to perform a snapshot search over all snapshots of parameters stored in the snapshot database 10300 on the basis of the selected search criterion and the request for snapshot search for snapshots of parameters under the search criterion for one or more of the plurality of devices 10410, 10420, and 10430 to obtain the snapshot search result which includes the one or more searched snapshots of parameters that match the search criterion. The device management application 10200 is configured to send the snapshot search result to the snapshot search result interface 10140.

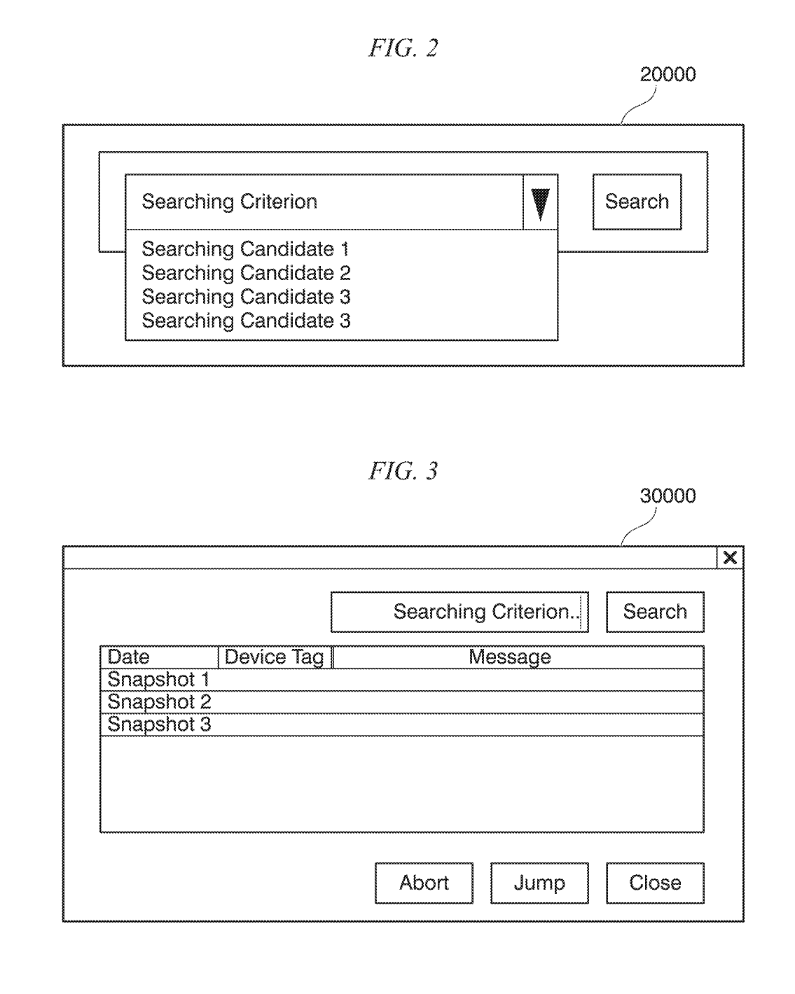

The snapshot search result interface 10140 is configured to acquire a snapshot search result which includes one or more searched snapshots of parameters that match the search criterion. Each of the snapshots includes one or more parameters that represent a state of a respective one of the plurality of devices 10410, 10420, and 10430 at a respective point of time. The snapshot search result interface 10140 is configured to display, on a display screen 30000, as shown in FIG. 3, the snapshot search result which includes searched snapshots 1, 2 and 3 of parameters that match the selected search criterion, associated with and together with the selected search criterion, so that user or operator can view at the same time both the searched snapshots 1, 2 and 3 of parameters that match the selected search criterion and the selected search criterion. The snapshot search result interface 10140 is configured to identify one or more snapshots or parameters selected from the searched snapshots of parameters that match the selected search criterion. The snapshot search result includes at least one snapshot set that includes a set of parameters which represents a history of status at a plurality of different points of time of a respective device of the plurality of devices 10410, 10420, and 10430.

The snapshot search prompt interface 10120, the snapshot search result interface 10140 and the device management application 10200 are implemented by the one or more display screens of the one or more display devices, the one or more hardware processors and the one or more software components including instructions to be executed by the one or more hardware processors.

The snapshot database 10300 stores a plurality of snapshot sets for the plurality of devices 10410, 10420, and 10430, wherein each snapshot set includes a set of parameters which represents a history of status at a plurality of different points of time of a respective device of the plurality of devices 10410, 10420, and 10430. Users can initiate the operation on mobile device to take snapshot of a field device at a certain point of time, then device snapshot is saved and stored into the mobile device database. One snapshot could have a variety of parameter information, which includes all the information when one or more field devices are exposed/working in an industrial plant environment, such as upper range limit for pressure, lower range limit for pressure, temperature, device status, device address, device type, current, etc.

The term “snapshot” refers to a parameter or a set of parameters that represents a certain state of a field device in a particular point of time wherein the parameter or the set of parameters are not indexed. For example, one snapshot contains a variety of parameter information at one particular point of time for one field device. Parameter information includes all the information when field device is exposed/working in an industrial plant environment, for example, upper range limit for pressure, lower range limit for pressure, temperature, device status, device address, current. Different snapshots for a particular field device represent states of that particular field device at different points of time. In other word, each snapshot represents a state of a field device at a single point of time. In a database or repository, there are a plurality of snapshot sets, each snapshot set includes a plurality of snapshots representing status of a respective or particular field device at a plurality of points of time, in other words, each snapshot set represents historical trends of status of a respective or particular field device over time if there can be found some coherence among snapshots of each snapshot set. Different snapshots for one field device could represent the historical trends of status of that field device. A snapshot represents a set of parameters taken at a certain point of time for a certain field device. Different snapshots for a particular field device could indicate the historical trends of status of that field device. In some cases, types of parameters of the snapshots as the search result include string, numeric, bitenum, enum, date, and combination of date and time, and in some other cases, it may also include other types of parameters which could be indexed.

The snapshot search result interface 10140 is configured to identify one or more selected snapshots or parameters which are selected by user or operator from the snapshot search result which includes the one or more searched snapshots of parameters that match the search criterion. The snapshot search result interface 10140 is configured to send the identified one or more selected snapshots or parameters. The device management application 10200 is configured to receive the one or more selected snapshots or parameters from the snapshot search result interface 10140. The device management application 10200 is configured to manage one or more field devices 10410, 10420, and 10430 based on the one or more selected snapshots or parameters.

This device management application 10200 can be applicable to any available plant management system.

For example, if this device management application 10200 is applied to a distributed control system, then the device management application 10200 is configured to manage a device controller which is configured to control the field devices 10410, 10420, and 10430.

If this device management application 10200 is applied to a personal computer-based configuration tool, then the device management application 10200 is configured to manage the field devices 10410, 10420, and 10430. For example, by checking and comparing the parameter information in snapshots of parameters, user or operator could identify alarms and causes of the alarms with ease and convenience, and with these information, user or operator could carry out configuration, maintenance and other operations for the plurality of field devices in the industrial plant.

This device management application 10200 can be integrated in or co-operate with a plant resource manager which is a platform that gives online access to all the field devices 10410, 10420, and 10430 via a field digital network which also works with the distributed control system.

In some cases, the device management application 10200 can be configured to be communicatively coupled directly or indirectly to the plurality of field devices 10410, 10420, and 10430 in an industrial plant. The device management application 10200 is configured to acquire a snapshot of parameter directly or indirectly from one or more of the plurality of devices 10410, 10420, and 10430. The device management application 10200 is configured to store the snapshot of parameter in the snapshot database 10300.

The device management application 10200 can be configured to automatically reflect the one or more selected snapshots or parameters to one or more other devices as one or more target field devices that have the one or more selected snapshots or parameters. For example, the device management application 10200 is configured to automatically reflect the one or more selected snapshots or parameters of the target field device 10410 to the other field devices 10420 and 10430. In other words, the device management application 10200 is configured to show all the other field devices, which have the same selected snapshots or parameters of the searched target device, in order for cross reference, checking, comparing, and identifying parameter information. The device management application 10200 is configured to export the searching result to external device management application to achieve reflecting the searched parameter value to other field devices.

The device management application 10200 can be configured to automatically identify one or more alarms from the snapshots as the search results. For example, the device management application 10200 is configured to automatically identify an alarm from the snapshots as the search results, in which the alarm notifies that the field device 10410 is in abnormal state.

The device management application 10200 can be configured to automatically identify one or more causes for the one or more alarms identified. For example, the device management application 10200 is configured to automatically identify a type of abnormality for the field device 10410 notified by the alarm identified.

The device management application 10200 can be configured to automatically identify the field devices 10410, 10420, and 10430 or the number of the field devices 10410, 10420, and 10430 to which the same alarm is applied, so that user or operator will be notified with the field devices 10410, 10420, and 10430 are in the same abnormal state.

The device management application 10200 can be configured to compare parameters of the snapshots as the search result between or among at least two different field devices included in the plurality of devices 10410, 10420, and 10430, in order for the device management application 10200 to identify the same or difference in the parameters of the snapshots as the search result between or among the at least two different field devices included in the plurality of devices 10410, 10420, and 10430 to allow user or operator to identify at least one of trend and coherence among the snapshots as the search results in different points of time over at least two devices included in the plurality of devices 10410, 10420, and 10430.

The device management application 10200 can be configured to filter parameters of the snapshots as the search result, which could realize further search of parameter information within the search result.

The device management application 10200 can be configured to sort parameters of the snapshots as the search result, which could realize further search of parameter information within the search result.

The device management application 10200 can be configured to display at least one of trend and coherence among the snapshots as the search results in different points of time over at least two devices included in the plurality of devices 10410, 10420, and 10430, so that user or operator can identify the at least one of trend and coherence.

The snapshot search interface 10100 for snapshot search allows user to identify the desired snapshot or snapshots quickly based on searching criterion. The snapshot search interface 10100 is effective to avoid time consuming for the user to browse through all the parameter snapshots.

The snapshot search interface 10100 for snapshot search allows user to see the trend and/or coherence among different snapshots for better data analysis. Some parameter snapshot can contain thousands of parameter information internally. Even in that case, it will be easy to locate the desired information of a particular parameter.

The snapshot search interface 10100 for snapshot search allows the snapshot search results to be integrated with one or more external device management applications for further data processing by additional processing such as reflecting the searched parameter value to other devices, identifying alarms and what causes the alarm, identifying how many devices with the same alarms, comparing, filtering, and sorting as mentioned above. User does no longer need to manually browsing the snapshots one by one for observing the coherence among different snapshots.

The snapshot search interface 10100 for snapshot search can be used a number of different scenarios such as the following three scenarios.

Scenario 1: Operator or user wants to unify a parameter value for some devices. Operator or user can open any parameter snapshots of the targeted device, find the wanted parameter A and launch a parameter search prompt, by selecting a candidate Parameter A≠Expected value and search. In the search result list view device tag column, operator or user will be able to quickly identify the devices that have a different value of parameter A. Hence operator or user can directly manage those devices to comply with the unified value instead of manually checking each device.

Scenario 2: Operator or user wants to investigate the malfunctioning of a device. Operator or user can search for the diagnostic and/or alarm parameter and find all snapshots within which the diagnostic parameter status is triggered. By checking these snapshots, operator or user will be able to gather more information such as the frequency of malfunctioning and historical trend of the diagnostic parameter.

Scenario 3: Operator or user wants to count devices with abnormality. Operator or user can search for certain parameter that indicates a specific abnormality. In the result view, the system will display the device tags for all the snapshots that satisfy the searching criterion. Hence operator or user will know how many devices have abnormality.

[Snapshot Search Process]

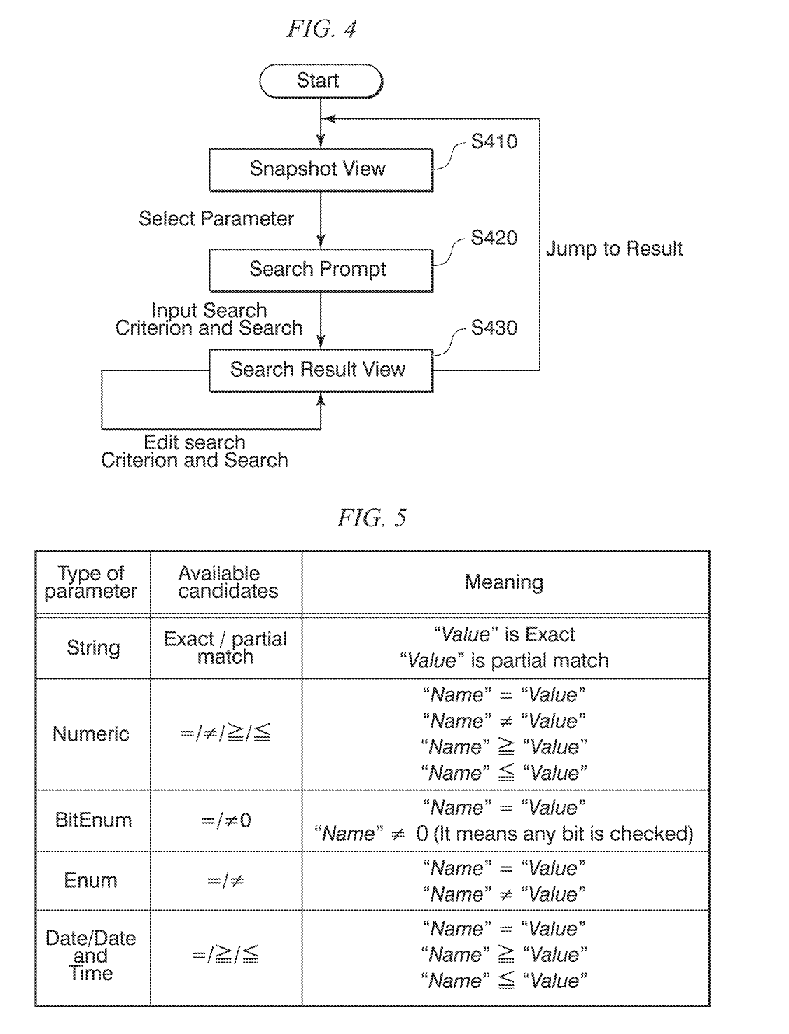

FIG. 4 is a flow chart of the snapshot search process to be performed by the snapshot search system shown in FIG. 1.

In step S410, user opens any parameter snapshot and double click a parameter, a search prompt as shown in FIG. 2 will be displayed for user to enter searching criterion. User selects one of parameters String, Numeric, BitEnum, Enum and Date, as shown in FIG. 5.

In step S420, in the search prompt, each parameter category will have distinctive predetermined searching candidates as shown in FIG. 5.

In step S430, user determines the search criterion and presses search button as shown in FIG. 2. After user has determined the search criterion and press search button, a user interface shown in FIG. 3 will be displayed containing all matched searching result from database. User can double click on any item from the list or press jump button to open the desired snapshot or snapshots. Also, user can re-search the snapshots by edit the search criterion in the textbox and pressing search button again. For searching process that might be taking a long time, user can press abort button any time during searching. User can close the window by pressing closing button or exit button at the top-right corner. Any string that matches the searching criterion will be highlighted in the searched results list.

Each element or device for the system or apparatus described above can be implemented by hardware with or without software. In some cases, the system or apparatus may be implemented by one or more hardware processors and one or more software components wherein the one or more software components are to be executed by the one or more hardware processors to implement each element or device for the system or apparatus. In some other cases, the system or apparatus may be implemented by a system of circuits or circuitry configured to perform each operation of each element or device for the system or apparatus.

The systems and methods in the above-described embodiments may be deployed in part or in whole through a machine or circuitry that executes computer software, software components, program codes, and/or instructions on one or more processors. The one or more processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more processors may enable execution of multiple programs, threads, and codes. The threads may be executed simultaneously to enhance the performance of the one or more processors and to facilitate simultaneous operations of the application. Program codes, program instructions and the like described herein may be implemented in one or more threads. The one or more processors may include memory that stores codes, instructions and programs as described herein. The processor may access a non-transitory processor-readable storage medium through an interface that may store codes, instructions and programs as described herein and elsewhere. The non-transitory processor-readable storage medium associated with the processor for storing programs, codes, program instructions or other type of instructions capable of being executed by the computing or processing device may include but may not be limited to one or more of a memory, hard disk, flash drive, RAM, ROM, CD-ROM, DVD, cache and the like.

A processor may include one or more cores that may enhance speed and performance of a multiprocessor. In some embodiments, the process may be a dual core processor, quad core processors, other chip-level multiprocessor and the like that combine two or more independent cores.

The methods and systems described herein may be deployed in part or in whole through a machine that executes computer software on a server, client, firewall, gateway, hub, router, or other such computer and/or networking hardware.

The software program may be associated with one or more client that may include a file client, print client, domain client, internet client, intranet client and other variants such as secondary client, host client, distributed client and the like. The client may include one or more of memories, processors, computer readable media, storage media, physical and virtual ports, communication devices, and interfaces capable of accessing other clients, servers, machines, and devices through a wired or a wireless medium, and the like. The programs or codes as described herein may be executed by the client. In addition, other devices required for execution of methods as described in this application may be considered as a part of the infrastructure associated with the client. The client may provide an interface to other devices including servers, other clients, printers, database servers, print servers, file servers, communication servers, distributed servers and the like. This coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The software program may be associated with one or more servers that may include a file server, print server, domain server, internet server, intranet server and other variants such as secondary server, host server, distributed server and the like. The server may include one or more of memories, processors, computer readable media, storage media, physical and virtual ports, communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server. The server may provide an interface to other devices including clients, other servers, printers, database servers, print servers, file servers, communication servers, distributed servers, social networks, and the like. This coupling and/or connection may facilitate remote execution of program across the network. The networking of some or all of these devices may facilitate parallel processing of a program or method at one or more locations. Any of the devices attached to the server through an interface may include at least one storage medium capable of storing programs, codes and/or instructions. A central repository may provide program instructions to be executed on different devices. In this implementation, the remote repository may act as a storage medium for program codes, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing devices associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory, for example, USB sticks or keys, floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods, devices, apparatus, and systems described herein may transform physical and/or or intangible items from one state to another. The methods and systems described herein may also transform data representing physical and/or intangible items from one state to another.

The modules, engines, components, and elements described herein, including in flow charts and block diagrams throughout the figures, imply logical boundaries between the modules, engines, components, and elements. However, according to software or hardware engineering practices, the modules, engines, components, and elements and the functions thereof may be implemented on one or more processors, computers, machines through computer executable media, which are capable of executing program instructions stored thereon as a monolithic software structure, as standalone software modules, or as modules that employ external routines, codes, services, or any combination of these, and all such implementations may be within the scope of the present disclosure. Examples of such machines may include, but is not limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, processor-embedded eyewear and the like. Furthermore, the modules, engines, components, and elements in the flow chart and block diagrams or any other logical component may be implemented on one or more machines, computers or processors capable of executing program instructions. Whereas the foregoing descriptions and drawings to which the descriptions have been referred set forth some functional aspects of the disclosed systems, no particular arrangement of software for implementing these functional aspects should be inferred from these descriptions unless explicitly stated or otherwise clear from the context. It will also be appreciated that the various steps identified and described above may be varied, and that the order of steps may be adapted to particular applications of the techniques disclosed herein. All such variations and modifications are intended to fall within the scope of this disclosure. The descriptions of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The above described snapshot search system or apparatus described above can be implemented by in part or entirely artificial intelligence. The artificial intelligence snapshot search system can include snapshot search technology, fuzzy logic and neural networks that enable user to automatically conduct snapshot search over a plurality of field devices in a plant.

While certain embodiments of the present inventions have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system for snapshot search over a plurality of devices in an industrial plant, the system comprising:
a snapshot search prompt interface configured to receive entry of search criterion, the snapshot search prompt interface configured to edit the search criterion entered, the snapshot search prompt interface configured to display one or more search criterion candidates based on the search criterion entered or edited, the snapshot search prompt interface configured to output selected search criterion and a request for snapshot search for snapshots of parameters under the search criterion for one or more of the plurality of devices; and
a snapshot search result interface configured to acquire a snapshot search result which includes one or more searched snapshots of parameters that match the search criterion, each of the snapshots including one or more parameters that represent a state of a respective one of the plurality of devices at a respective point of time, the snapshot search result interface configured to display the snapshot search result which includes the one or more searched snapshots of parameters that match the search criterion, associated with the selected search criterion,
wherein the snapshot search prompt interface and the snapshot search result interface are implemented by one or more display screens of one or more display devices, one or more hardware processors and one or more software components including instructions to be executed by the one or more hardware processors.

2. The system according to claim 1, wherein the snapshot search result interface is configured to identify one or more snapshots or parameters selected from the searched snapshots of parameters that match the selected search criterion.

3. The system according to claim 1, wherein the snapshot search result includes at least one snapshot set that includes a set of parameters which represents a history of status at a plurality of different points of time of a respective device of the plurality of devices.

4. The system according to claim 3, further comprising:
a snapshot storage that stores a plurality of snapshot sets for the plurality of devices, each snapshot set including a set of parameters which represents a history of status at a plurality of different points of time of a respective device of the plurality of devices; and
a device management application configured to receive, from the snapshot search prompt interface, the selected search criterion and the request for snapshot search for snapshots of parameters under the search criterion for one or more of the plurality of devices, the device management application configured to have an access to the storage, the device management application configured to perform a snapshot search over all snapshots of parameters stored in the snapshot storage on the basis of the selected search criterion and the request for snapshot search for snapshots of parameters under the search criterion for one or more of the plurality of devices to obtain the snapshot search result which includes the one or more searched snapshots of parameters that match the search criterion, the device management application configured to send the snapshot search result to the snapshot search result interface,
wherein the snapshot search prompt interface, the snapshot search result interface and the device management application are implemented by the one or more display screens of the one or more display devices, the one or more hardware processors and the one or more software components including instructions to be executed by the one or more hardware processors.

5. The system according to claim 4,
wherein the snapshot search result interface is configured to identify one or more selected snapshots or parameters which are selected from the snapshot search result which includes the one or more searched snapshots of parameters that match the search criterion, and
wherein the device management application is configured to receive the one or more selected snapshots or parameters from the snapshot search result interface, the device management application is configured to manage one or more devices based on the one or more selected snapshots or parameters.

6. The system according to claim 5, wherein the device management application is configured to be communicatively coupled to the plurality of devices, the device management application is configured to acquire a snapshot of parameter from one or more of the plurality of devices, the device management application is configured to store the snapshot of parameter in the storage.

7. The system according to claim 5, wherein the device management application is configured to reflect the one or more selected snapshots or parameters to one or more other devices as one or more target devices that have the one or more selected snapshots or parameters.

8. The system according to claim 5, wherein the device management application is configured to identify one or more alarms from the snapshots as the search results.

9. The system according to claim 8, wherein the device management application is configured to identify one or more causes for the one or more alarms identified.

10. The system according to claim 8, wherein the device management application is configured to identify devices to which the same alarm is applied, the devices being included in the plurality of devices.

11. The system according to claim 5, wherein the device management application is configured to compare parameters of the snapshots as the search result between at least two different devices included in the plurality of devices.

12. The system according to claim 5, wherein the device management application is configured to filter parameters of the snapshots as the search result.

13. The system according to claim 5, wherein the device management application is configured to sort parameters of the snapshots as the search result.

14. The system according to claim 5, wherein the device management application is configured to display at least one of trend and coherence among the snapshots as the search results in different points of time over at least two devices included in the plurality of devices.

15. The system according to claim 5, wherein the device management application system is integrated in a system configured to perform at least one of management and control to the plurality of devices.

16. The system according to claim 5, wherein types of parameters of the snapshots as the search result include string, numeric, bitenum, enum, date, and combination of date and time.

17. A plant management system comprising:
a snapshot storage comprising at least one of a database and a repository that stores a plurality of snapshot sets for a plurality of devices in an industrial plant, each snapshot set including a set of parameters which represents a history of status at a plurality of different points of time of a respective device of the plurality of devices;
a snapshot search prompt interface configured to receive entry of search criterion, the snapshot search prompt interface configured to edit the search criterion entered, the snapshot search prompt interface configured to display one or more search criterion candidates based on the search criterion entered or edited, the snapshot search prompt interface configured to output selected search criterion and a request for snapshot search for snapshots of parameters under the search criterion for one or more of the plurality of devices; and
a device management application configured to acquire each snapshot set from the respective device of the plurality of devices, the device management application configured to store each snapshot set in the snapshot storage, the device management application configured to receive, from the snapshot search prompt interface, the selected search criterion and the request for snapshot search for snapshots of parameters under the search criterion for one or more of the plurality of devices, the device management application configured to have an access to the storage, the device management application configured to perform a snapshot search over all snapshots of parameters stored in the snapshot storage on the basis of the selected search criterion and the request for snapshot search for snapshots of parameters under the search criterion for one or more of the plurality of devices to obtain the snapshot search result which includes the one or more searched snapshots of parameters that match the search criterion; and
a snapshot search result interface configured to receive, from the device management application, the snapshot search result which includes one or more searched snapshots of parameters that match the search criterion, each of the snapshots including one or more parameters that represent a state of a respective one of the plurality of devices at a respective point of time, the snapshot search result interface configured to display the snapshot search result which includes the one or more searched snapshots of parameters that match the search criterion, associated with the selected search criterion,
wherein the snapshot search prompt interface, the snapshot search result interface and the device management application are implemented by a display screen of a display device, one or more hardware processors and the one or more software components including instructions to be executed by the one or more hardware processors.

18. The system according to claim 17,
wherein the snapshot search result interface is configured to identify one or more selected snapshots or parameters which are selected from the snapshot search result which includes the one or more searched snapshots of parameters that match the search criterion, and
wherein the device management application is configured to receive the one or more selected snapshots or parameters from the snapshot search result interface, the device management application is configured to manage one or more devices based on the one or more selected snapshots or parameters.

19. The system according to claim 18, wherein the device management application is configured to reflect the one or more selected snapshots or parameters to one or more other devices than one or more target devices that have the one or more selected snapshots or parameters.

20. A computer-implemented method for snapshot search over a plurality of devices in an industrial plant, the method comprising:
receiving entry of search criterion;
editing the search criterion;
displaying, on one or more display screens of one or more display devices, one or more search criterion candidates based on the search criterion entered or edited;
outputting selected search criterion and a request for snapshot search for snapshots of parameters under the search criterion for one or more of the plurality of devices;
performing a snapshot search over all snapshots of parameters stored in a snapshot storage on the basis of the selected search criterion and the request for snapshot search for snapshots of parameters under the search criterion for one or more of the plurality of devices;
acquiring a snapshot search result which includes one or more searched snapshots of parameters that match the search criterion, wherein each of the snapshots including one or more parameters represent a state of a respective one of the plurality of devices at a respective point of time; and
displaying, the on one or more display screens of the one or more display devices, the snapshot search result which includes the one or more searched snapshots of parameters that match the search criterion, associated with the selected search criterion.

21. The computer-implemented method according to claim 20, further comprising:
identifying one or more selected snapshots or parameters which are selected from the snapshot search result which includes the one or more searched snapshots of parameters that match the search criterion for managing one or more devices based on the one or more selected snapshots or parameters.

22. The computer-implemented method according to claim 21, further comprising:
reflecting the one or more selected snapshots or parameters to one or more other devices as one or more target devices that have the one or more selected snapshots or parameters.

23. The computer-implemented method according to claim 21, further comprising:
displaying, the on one or more display screens of the one or more display devices, at least one of trend and coherence among the snapshots as the search results in different points of time over at least two devices included in the plurality of devices.

24. A non-transitory computer readable storage medium that stores computer-executable instructions or codes, when executed by one or more hardware processing devices, to cause the one or more hardware processing devices to perform as at least:
a snapshot search prompt interface configured to receive entry of search criterion, the snapshot search prompt interface configured to edit the search criterion entered, the snapshot search prompt interface configured to display one or more search criterion candidates based on the search criterion entered or edited, the snapshot search prompt interface configured to output selected search criterion and a request for snapshot search for snapshots of parameters under the search criterion for one or more of the plurality of devices; and
a snapshot search result interface configured to acquire a snapshot search result which includes one or more searched snapshots of parameters that match the search criterion, each of the snapshots including one or more parameters that represent a state of a respective one of the plurality of devices at a respective point of time, the snapshot search result interface configured to display the snapshot search result which includes the one or more searched snapshots of parameters that match the search criterion, associated with the selected search criterion.
